(19) United States
(12) Patent Application Publication
(10) Pub. No.: US 2015/0316453 A1
(43) Pub. Date: Nov. 5, 2015

(54) METHOD FOR FORMING A LIQUID FILM ON A SUBSTRATE

(71) Applicant: COMMISSARIAT À L'ÉNERGIE ATOMIQUE ET AUX ÉNERGIES ALTERNATIVES, Paris (FR)

(72) Inventor: Yves HENNEQUIN, AMSTERDAM (NL)

(21) Appl. No.: 14/647,391

(22) PCT Filed: Nov. 26, 2013
(86) PCT No.: PCT/EP2013/074750

§ 371 Date: May 26, 2015

(30) Foreign Application Priority Data
Nov. 27, 2012 (FR) 12 61282

(51) Int. Cl. G01N 1/30

(52) U.S. Cl. CPC G01N 1/30; G01N 2001/305; G01N 2001/307

(57) ABSTRACT

This method for forming a liquid film on a substrate comprises the steps of placing the substrate in a chamber, and depositing a composition on the substrate, the composition including water, introducing a volatile liquid into the chamber, and closing the chamber for a predetermined period, the volatile liquid evaporating in the chamber during this closing step. The method further comprises at least partial extraction, out of the chamber, vapor formed by the evaporation of the volatile liquid, this extraction producing spreading out of the composition on the substrate, said spread composition then forming the liquid film on the substrate.

### BACKGROUND OF THE INVENTION

The present invention relates to a method for forming a liquid film on a substrate. The formation method comprises the following steps:

placing the substrate in a chamber, and depositing a composition on the substrate, the composition including water,

introducing a volatile liquid into the chamber, and

closing the chamber for a predetermined duration, the volatile liquid evaporating in the chamber during this closing step.

The invention in particular applies to the detection of particles of micrometric and sub-micrometric size, notably biological particles, such as cells, bacteria or further viruses. The invention also applies to the detection of particles in the form of microbeads. The composition then includes said particles to be detected, and the substrate is a transparent slide, the transparent slide being intended to be illuminated by a light source, for acquiring by means of an optical detection system at least one image of the composition comprising the particles.

In order to acquire images of these particles with a large size image sensor, i.e. a sensor having an area of a few cm², or even a few tens of cm², the composition should be spread out at best on the transparent slide, in order to form a film of small thickness and with an area equivalent to that of the image sensor. By small thickness, is meant a thickness with a value of less than 500 μm, preferably comprised between 50 μm and 200 μm.

A first technique, so-called spin coating, consists of depositing the composition on the substrate and of causing rotation of the substrate, in order to spread the composition over the substrate by the action of the centrifugal force. However, this first technique is complex to apply, the spreading of the composition being relatively difficult to control. Further, when the composition includes bacteria, the introduction of the composition into a device able to apply this technique may contaminate the composition.

A second technique, so-called dip coating, consists of dipping the substrate in a reservoir including the composition, and then of gently withdrawing the substrate from this reservoir. A film of this composition is then formed at the surface of the substrate. However, this requires a large volume of said composition, typically of a few tens of and such a volume is not necessarily available.

A third technique is described in the article entitled “Overcoming the ‘coffee-stain’ effect by compositional Marangoni-flow-assisted drop-drying” of Majumder et al., published in “The Journal of Physical Chemistry” in 2012. This third technique consists of depositing a drop of water on a Teflon substrate and of placing this substrate in an atmosphere saturated with ethanol, for example inside a Petri dish. The drop then spreads over the substrate during the gradual presence of the substrate in the atmosphere saturated with ethanol. The substrate should be placed in this atmosphere saturated with ethanol for a period of the order of 1,000 seconds, in order to observe proper spreading of the drop.

However, this spreading of the drop is not optimum, and requires a relatively large amount of the composition in order to obtain a film having an area of a few cm², or even of a few tens of cm².

### SUMMARY OF THE INVENTION

The object of the invention is therefore to propose a method for forming a liquid film on a substrate, the film being formed by spreading out a composition, the method allowing improvement in the spreading of the composition over the substrate.

For this purpose, the object of the invention is a method of the aforementioned type, wherein the method further comprises at least partial extraction, outside of the chamber, of the vapor formed by the evaporation of the volatile liquid, this extraction producing a spreading of the composition over the substrate, said spread composition then forming the liquid film on the substrate.

Unlike the method of the state of the art corresponding to the third technique, the spreading of the composition according to the invention is not observed during the step for hermetically closing the chamber, i.e. during the evaporation of the volatile liquid inside the chamber, but only from the moment when the vapor formed by evaporation of the volatile liquid is at least partly extracted out of the chamber.

According to other advantageous aspects of the invention, the method comprises one or more of the following features, taken individually or according to all the technically possible combinations:

the predetermined period has a value comprised between 1 minute and 30 minutes, preferably comprised between 5 minutes and 20 minutes, still preferably substantially equal to 10 minutes;

during introduction of the volatile liquid, the volatile liquid is positioned away from the composition, in the absence of contact between the volatile liquid and the composition;

the volatile liquid introduced into the chamber includes an alcohol, such as ethanol;

the chamber is a box, such as a Petri dish, the box including a lid and a receptacle having an aperture, the lid being movable between an open position in which the lid is away from the aperture of the receptacle and a closed position in which the lid is able to obturate the aperture of the receptacle, said closed position corresponding to hermetic closure of the box, and during the closing step, the lid is moved from its open position to its closed position, and then maintained in the closed position for the predetermined period, and during the extraction step, the lid is moved from its closed position to its open position, and then maintained in the open position;

the receptacle includes a bottom, the volatile liquid is positioned against the bottom during the introduction step, and the box further includes at least one shim for maintaining the substrate away from the bottom, in order to position the volatile liquid away from the composition during the introduction step;

the composition further comprises particles, a surfactant and a hydrophilic polymer, the particles having a diameter preferably of less than 10 μm, still preferably less than 1 μm, the surfactant having a concentration preferably at least equal to the critical micellar concentration, and the hydrophilic polymer has a boiling temperature above that of water, the polymer preferably being a polyethylene glycol defined by the following formula:

H(—OCH₂ CH₂—)ₙOH, wherein n represents the number of oxyethylene unit(s) of the polymer;

the composition has a volume with a value comprised between 0.5 μL and 5 μL;

the substrate is made in a hydrophilic material, such as glass or still further a plastic material;

the substrate is a transparent slide, the transparent slide being intended to be illuminated by a light source, for acquiring, by means of an optical detection system, at least one image of the composition comprising particles; and

the composition further comprises particles, the particles being biological species, such as live biological species, for example bacteria.

### BRIEF DESCRIPTION OF THE DRAWINGS

The features and advantages of the invention will become apparent upon reading the description which follows, only given as a non-limiting example, and made with reference to the appended drawings, wherein:

FIG. 1 is a schematic sectional illustration of a box-shaped chamber into which a volatile liquid is introduced after having deposited a composition on a substrate placed in this chamber,

FIG. 2 is a flow chart of the method for forming the film according to the invention, comprising the introduction of the volatile liquid into the chamber, the closing of the chamber for a predetermined period, the volatile liquid evaporating in the chamber during this closure, and at least partial extraction of the vapor formed by evaporation of the volatile liquid, out of the chamber,

FIG. 3 is a curve illustrating the time-dependent change of the radius of the composition, from the moment when the vapor formed by evaporation of the liquid is extracted from the chamber, and

FIG. 4 is a schematic illustration of a system for optical detection of particles, comprising a light source, the substrate as a transparent slide over which is laid out the composition, and a device for acquiring images of the illuminated composition.

### DETAILED DESCRIPTION OF PREFERRED EMBODIMENTS

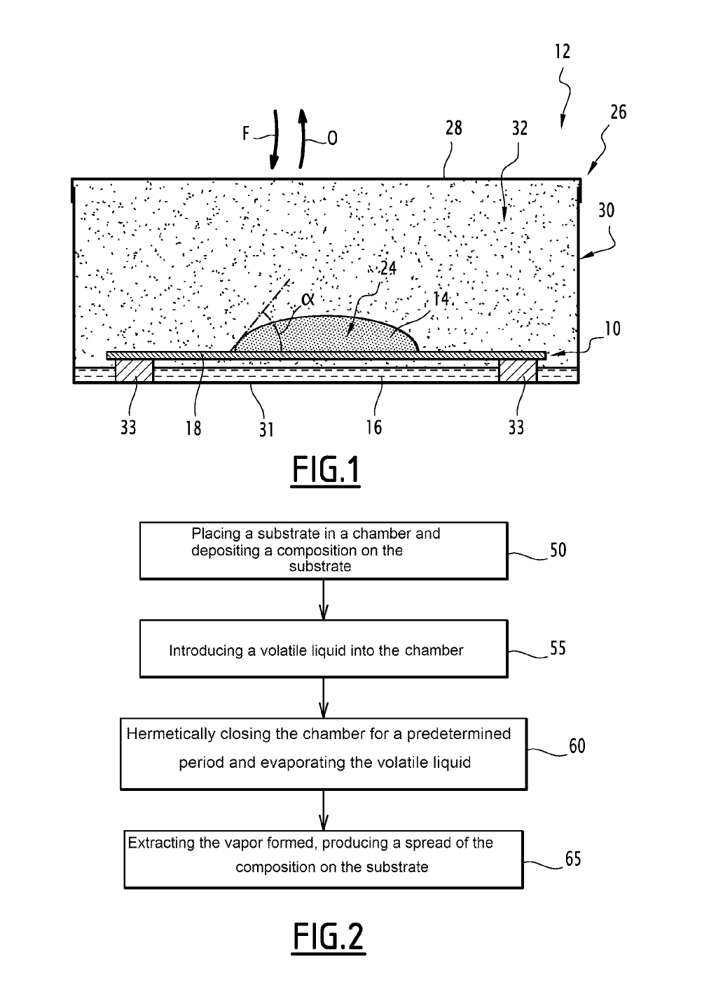

In FIG. 1, a substrate 10 is placed in the chamber 12, and a composition 14 including water as well as particles 24, is deposited on the substrate 10. A volatile liquid 16 is positioned in the chamber 12, and the chamber 12 is hermetically closed, the volatile liquid 16 evaporating inside the chamber 12 when the latter is hermetically closed.

The substrate 10 is preferably made in a hydrophilic material, such as glass or further such as a plastic material which has been made hydrophilic.

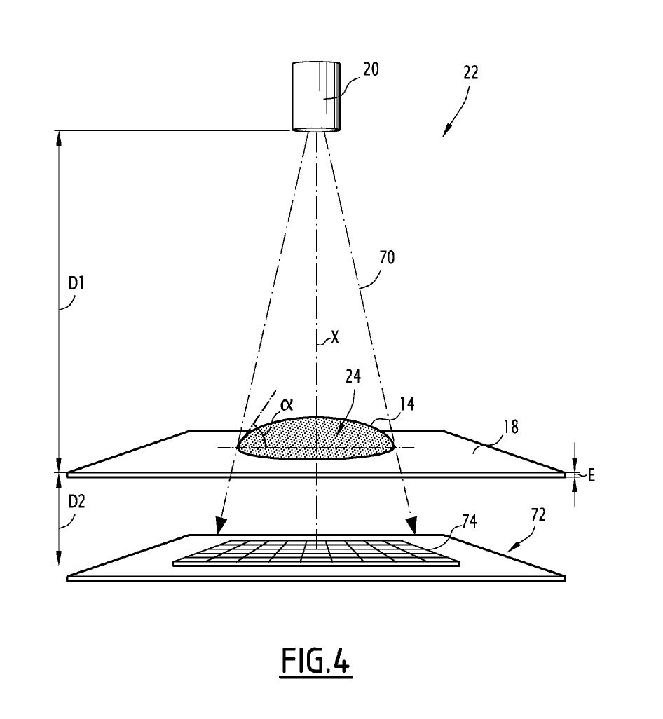

The substrate 10 for example, is in the form of a transparent slide 18 intended to be illuminated by a light source 20, for acquiring by means of an optical detection system 22, at least one image of the composition 14 comprising the particles 24, as illustrated in FIG. 4.

The chamber 12 for example is a box 26, such as a Petri dish, the box 26 including a lid 28 and a receptacle 30 having a bottom 31 and an aperture 32. The lid 28 is movable between an open position in which the lid 28 is away from the aperture 32 of the receptacle and a closed position in which the lid 28 is able to obturate the aperture 32 of the receptacle, said closed position corresponding to hermetic closure of the box 26.

In the exemplary embodiment of FIG. 1, the chamber 12 is of a cylindrical form. The chamber 12 for example has a diameter of about 10 cm and a height of about 1.5 cm.

Additionally, the chamber 12 includes at least one shim 33 for maintaining the substrate 10 away from the bottom 31 of the receptacle, in order to position the volatile liquid 16 away from the composition 14 when it is introduced into the chamber 12. In the exemplary embodiment of FIG. 1, the chamber 12 includes two maintaining shims 33.

The composition 14 for example comprises the particles to be detected 24 and a solution, the solution including water, a surfactant and preferably a hydrophilic polymer. In other words, the composition 14 is a dispersion of particles to be detected 24 in an aqueous solution comprising water, the surfactant and the hydrophilic polymer.

In the described exemplary embodiment, the solution of the composition 14 consists of water, of the surfactant and of the hydrophilic polymer. The composition 14 then consists of the particles to be detected 24, of water, of the surfactant and of the hydrophilic polymer.

The composition 14 has a volume with a value comprised between 0.5 μL and 5 μL.

The hydrophilic polymer has a boiling temperature above that of water. The hydrophilic polymer for example is a polyethylene glycol defined by the following formula:

H(—OCH₂ CH₂—)ₙOH

wherein n represents the number of oxyethylene unit(s) of the polymer.

The number n of oxyethylene unit(s) is an integer, preferably comprised between 1 and 180, still preferably comprised between 4 and 16, still preferably equal to 13.

The number n of units is for example equal to 2, and the polymer is then called diethylene glycol, also noted as DiEG.

Alternatively, the number n of oxyethylene units is equal to 13, and the hydrophilic polymer is called polyethylene glycol 600, also noted as PEG 600, PEG 600 having a molecular weight of the order of 600 g/mol.

When the number n of oxyethylene units is equal to 13, the hydrophilic polymer, i.e. PEG 600, has a mass concentration preferably comprised between 0.2% and 0.8%, still preferably comprised between 0.4% and 0.6%.

Still alternatively, the number n of oxyethylene units is equal to 180, and the hydrophilic polymer is called polyethylene glycol 8000, also noted as PEG 8000, PEG 8000 having a molecular weight substantially equal to 8,000 g/mol.

The surfactant, also called a tenside, has a concentration preferably equal to the critical micellar concentration (CMC). The surfactant includes for example polyoxyethylene 20 sorbitan monolaurate, also known under the commercial name of TWEEN20.

Alternatively, the surfactant includes a copolymer of polyoxyethylene and of polyoxypropylene, such as a poloxamer, for example one known under the commercial name of PLURONIC F-68. Still alternatively, the surfactant includes sodium dodecylsulfate, also called SDS.

The surfactant, optionally completed with the hydrophilic polymer, is intended to form a film covering the particles 24 upon evaporation of the water of the solution 14. The addition of a hydrophilic polymer gives the possibility of extending the period, or duration, during which this film covers the particles 24.

The volatile liquid 16 positioned in the chamber 12 includes an alcohol, such as ethanol. In the described exemplary embodiment, the volatile liquid 16 consists of this alcohol, such as ethanol.

Alternatively, the volatile liquid 16 is isopropanol or any other volatile solvent.

The preferred volatile liquid 16 is however ethanol, since it is adapted to the case when the particles 24 are biological species, and more particularly live biological species, notably bacteria or any other microorganism. Under these particular conditions, it is actually preferable to have a not very aggressive volatile liquid 16 towards biological species 24.

The transparent slide 18 has a thickness E along a longitudinal direction X corresponding to the illumination direction of the composition 14 by the light source 20, as illustrated in FIG. 4. The thickness E for example has a value comprised between 10 μm and 100 μm, preferably comprised between 20 μm and 50 μm.

The slide 18 is preferably hydrophilic, so that a contact angle α, visible in FIG. 1, between the composition 14 and the slide 18 has a small value. The value of the contact angle α obtained between the hydrophilic slide 18 and the composition 14 is less than 20°, preferably less than 10°, still preferably of the order of a degree.

The hydrophilicity of the slide 18 is for example obtained by preparing the slide 18 according to the following steps. The first preparation step is sonication in soapy water for a period, or duration, of the order of 10 minutes. The soapy water for example includes water and washing up liquid, the water preferably being a pure water of type 1 according to the ISO 3696 standard, also known under the commercial name of Milli-Q. The second step is a rinsing step with water, such as Milli-Q water, with acetone and with isopropanol. The third step is a drying step, for example drying with nitrogen, and the fourth step is having an oxygen plasma pass for a period, or duration, of more than 15 seconds, preferably of the order of 30 seconds.

The method for forming a liquid film on the substrate 10, the film being formed by spreading of the composition 14, will now be described by means of FIG. 2.

During the initial step 50, the substrate 10 is placed in the chamber 12 and the composition 14 is deposited on the substrate 10, the composition 14 notably including water.

The substrate 10, for example in the form of a transparent slide 18, is preferably laid out on the maintaining shims 33, in order to be positioned away from the bottom 31 of the receptacle of the chamber 12.

The volatile liquid 16 is then introduced into the chamber 12, during step 55. The volatile liquid 16 is for example positioned against the bottom 31.

Upon introducing the volatile liquid 16, the latter is positioned away from the composition 14. During this introduction step, the volatile liquid 16 and the composition 14 are then not in contact with each other.

During the next step 60, the chamber 12 is hermetically closed for a predetermined period, or predetermined duration, the volatile liquid 16 then evaporating in the chamber 12 during this closing step. In other words, the substrate 10 during this closing step is placed under an atmosphere of the volatile liquid 16, for example under an ethanol atmosphere.

The predetermined period has a value comprised between 1 minute and 30 minutes, preferably comprised between 5 minutes and 20 minutes, still preferably equal to 10 minutes plus or minus 1 minute.

When the chamber 12 has the shape of the box 26 including the lid 28 and the receptacle 30, the lid 28 during this closing step 60 is moved from its open position to its closed position, as illustrated by the arrow F in FIG. 1, and the lid 28 is then maintained in a closed position for the predetermined period.

Finally, during step 65, after expiry of said predetermined period, the vapor formed by the evaporation of the liquid 16 is at least partly extracted out of the chamber 12. This at least partial extraction of the vapor formed earlier then produces spreading of the composition 14 on the substrate 10, this spread composition 14 forming the liquid film on the substrate 10.

When the chamber 12 has the shape of the box 26 including the lid 28 and the receptacle 30, the lid 28 during the extraction step 65 is moved from its closed position to its open position, as illustrated by the arrow O in FIG. 1, and the lid 28 is then maintained in the open position.

As the vapor of the liquid 16 is confined inside the chamber 12 during the closing step 60, the opening of the box 26, by displacement of the lid 28 from its closed position to its open position (arrow O), causes at least partial extraction of this vapor out of the chamber 12.

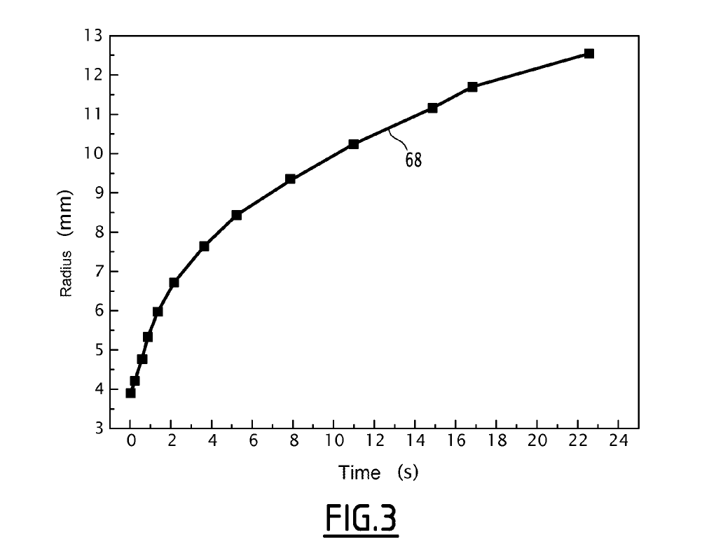

In FIG. 3, the curve 68 illustrates the time-dependent change of the radius of the composition 14 in a plane perpendicular to the longitudinal direction X, from the moment when the vapor formed by evaporation of the liquid is extracted from the chamber, i.e. from the beginning of step 65.

The curve 68 was obtained with a glass slide 18 which was made hydrophilic as described earlier, for a composition 14 having a volume of about 10 μl, and with the introduction of about 1 ml of ethanol into the chamber 12 and a predetermined period of 10 minutes for the closing step 60. The composition 14 was prepared with the following proportions: for a total volume total of 1 ml of the composition 14, 45 μl of 0.2% TWEEN20 surfactant and 600 μl of PEG 600 with a mass concentration equal to 0.5%.

The curve 68 then shows a very rapid change in the radius of the composition 14 versus time, i.e. a very rapid spreading of the composition 14 over the substrate 10 from the moment when the vapor formed by the evaporation of the liquid is extracted from the chamber. In the example of FIG. 3, the composition 14 initially has a radius of about 4 mm, and the value of the radius is doubled in a little more than 4 seconds from the beginning of step 65, the value of the radius being trebled at about 18 seconds after the beginning of step 65.

Thus, when the predetermined period of step 60 is equal to 10 minutes, the value of the radius of the composition 14 is trebled in a little more than 10 minutes with the formation method according to the invention, while with the formation method of the state of the art, trebling of the value of the radius is only obtained at best after about 1,500 seconds, i.e. 25 minutes.

The method according to the invention therefore allows a significant improvement in the spreading of the composition 14 over the substrate 10.

After forming the liquid film on the substrate 10 in accordance with the method according to the invention, the liquid film is illuminated by the light source 20 so that the particles 24 are detected by means of an optical detection system 22, visible in FIG. 4.

The light source 20 is able to emit a light beam 70 along the longitudinal direction X, in order to illuminate the composition 14 positioned on the transparent slide 18.

The light source 20 is positioned at a first distance D1 from the transparent slide 18 along the longitudinal direction X. The first distance D1 preferably has a value comprised between 1 cm and 30 cm, for example equal to 10 cm.

In the exemplary embodiment of FIG. 4, the light source 20 is a point-like source. The spatial coherence of the light source 20 is additionally improved, for example by coupling it with a pinhole, with a diameter comprised between 50 μm and 500 μm, placed in contact with the source 20.

The light source 20 is for example a light emitting diode, also called a LED, which is monochromatic and has sufficiently reduced dimensions so as to be considered as spatially coherent, the diameter of the light emitting diode being less than one tenth of the first distance D1 separating this light emitting diode from the slide 18. The light emitting diode of the light source 20 for example has an emission wavelength equal to 555 nm and a power equal to 1.7 W.

Alternatively, the light source 20 is a spatially or temporally coherent source, such as a laser diode (DL) or further a laser diode of the VCSEL (Vertical Cavity Surface Emitting Laser) type.

The optical detection system 22 comprises the light source 20, an image acquisition device 72, the transparent slide 18 and the composition 14 spread over the slide 18, the composition 14 including the particles to be detected 24.

The detection system 22 is intended for detecting the particles 24, during evaporation of the composition 14, this evaporation being de-correlated from the spreading, described earlier, of the composition 14 over the transparent slide 18.

The particles to be detected 24 for example are biological particles, i.e. cells (for example red corpuscles, white corpuscles or platelets), cell components (for example mitochondria), bacteria, viruses or any other molecule or molecule aggregates, notably protein aggregates.

Alternatively, the particles to be detected 24 are microbeads.

The particles to be detected 24 have a diameter preferably less than 1 μm, the diameter of the particles 24 being for example comprised between 50 nm and 1 μm, still preferably comprised between 10 nm and 1 μm.

The light beam 70 is able to directly illuminate the composition 14 positioned on the transparent slide 18.

The image acquisition device 72 comprises a photodetector array 74 including a plurality of pixels, not shown. Each pixel of the photodetector 74 has dimensions of less than or equal to 10 μm, or even 4 μm. Each pixel for example has the shape of a square, the side of which has a value of less than or equal to 10 μm, or even 4 μm. Alternatively, each pixel has the shape of a square with a side of 2.2 μm.

The acquisition device 72 is positioned at a second distance D2 from the transparent slide 18 along the longitudinal direction X. The second distance D2 has a value of less than 1 cm, and preferably comprised between 100 μm and 2 mm.

In the exemplary embodiment of FIG. 4, the second distance D2 is equal to 500 μm. By giving preference to a short distance between the acquisition device 72 and the transparent slide 18, it is possible to limit phenomena of interferences between different diffraction patterns when the composition 14 is illuminated.

The image acquisition device 72 is able to acquire images of the radiation transmitted by the slide 18 over which is laid out the composition 14 illuminated by the light beam 70. By transmitted radiation, is meant the radiation passing through the composition 14 and the slide 18, so that the acquisition device 72 and the light source 20 are located on either side of the transparent slide 18 and of the composition 14.

The photodetector array 74 is a two-dimensional image sensor, i.e. in a plane perpendicular to the longitudinal axis X. The photodetector array 74 is a pixelized image sensor, and for example a CMOS (Complementary Metal Oxide Semi-conductor) sensor.

Alternatively, the photodetector array 74 is a CCD (Charge-Coupled Device) sensor.

The images acquired by the photodetector array 74 are formed by the radiation directly transmitted by the illuminated composition 14, in the absence of any magnification optics positioned between the transparent slide 18 and the photodetector array 74. However, this does not exclude the presence of microlenses, each being coupled with a corresponding pixel of the sensor, these microlenses allow better collection of the signal. The photodetector array 74 is also called a lens-less imaging device, and is able to form an image of the composition 14, while being placed at a small distance from the latter. By small distance is meant a distance of less than 1 cm, the second distance D2 for example being of the order of 500 μm.

For optical detection of the particles 24, successive images of the composition 14 spread as a film and containing the particles 24 are then acquired by means of the optical detection system 22. Upon evaporation of the film, the formation of a skin covering the particles 24 is observed, the skin having a very small thickness, such as a thickness with a value comprised between 10 nm and 5 μm.

When the composition 14 is illuminated by the light source 20 under these conditions, the skin then plays the role of one or several microlenses formed above the particles 24, which allows improvement in the detection of these particles.

The addition of the hydrophilic polymer in the composition 14 allows extension of the period during which the skin remains in contact with the particles 24 upon evaporation of the composition 14. The hydrophilic polymer gives the possibility of extending the period of occurrence of the skin, while retaining proper spreading of the composition 14 over the slide 18. The contact angle a obtained between the slide 18 and the composition 14 actually has a value of less than 20°, preferably less than 1° and 10°, still preferably of the order of a degree.

The hydrophilic polymer also causes a reduction in the thickness of the obtained skin upon evaporation of the composition 14, which allows detection of particles 24 with a more reduced size, while retaining a good signal-to-noise ratio. Indeed, if the thickness of the skin is too large relatively to the particles 24 which one wishes to detect, then the signal-to-noise ratio decreases.

When the surfactant has a concentration at least equal to the critical micellar concentration, the composition 14 is even better spread, while having a sufficient evaporation rate for allowing the formation of the skin.

The detection system 22 then allows detection of the particles 24 having a diameter of very small value, such as for example particles having a diameter of 200 nm.

1. A method for forming a liquid film on a substrate, the method comprising the following steps:
placing the substrate in a chamber, and depositing a composition on the substrate, the composition including water,
introducing a volatile liquid into the chamber, and
closing the chamber for a predetermined period, the volatile liquid evaporating in the chamber during this closing step,
wherein the method being characterized in that it further comprises the following step:
at least partly extracting, out of the chamber, vapor formed by the evaporation of the volatile liquid, this extraction producing a spreading out of the composition on the support, said spread composition then forming the liquid film on the substrate.

2. The method according to claim 1, wherein the predetermined period has a value comprised between 1 minute and 30 minutes, preferably comprised between 5 minutes and 20 minutes, still preferably substantially equal to 10 minutes.

3. The method according to claim 1, wherein, during the introduction of the volatile liquid, the volatile liquid is positioned away from the composition, in the absence of any contact between the volatile liquid and the composition.

4. The method according to claim 1, wherein the volatile liquid introduced into the chamber includes an alcohol, such as ethanol.

5. The method according to claim 1, wherein the chamber is a box, the box including a lid and a receptacle having an aperture, the lid being movable between an open position in which the lid is away from the aperture of the receptacle and a closed position in which the lid is able to obturate the aperture of the receptacle, said closed position corresponding to hermetically closing the box, and
wherein, during the closing step, the lid is moved from its open position to its closed position, and then maintained in a closed position for the predetermined period, and during the extraction step, the lid is moved from its closed position to its open position, and then maintained in an open position.

6. The method according to claim 5, wherein the receptacle includes a bottom, the volatile liquid is positioned against the bottom during the introduction step, and the box further includes at least one shim for maintaining the substrate away from the bottom, in order to position the volatile liquid away from the composition during the introduction step.

7. The method according to claim 1, wherein the composition further comprises particles, a surfactant and a hydrophilic polymer, the hydrophilic polymer having a boiling temperature above that of water.

8. The method according to claim 1, wherein the composition has a volume with a value comprised between 0.5 μl and 5 μl.

9. The method according to claim wherein the substrate is made in a hydrophilic material.

10. The method according to claim 1, wherein the substrate is a transparent slide intended to be illuminated by a light source, for acquiring, by means of an optical detection system, at least one image of the composition comprising particles.

11. The method according to claim 1, wherein the composition further comprises particles, the particles being biological species, such as live biological species, for example bacteria.

12. The method according to claim 2, wherein the predetermined period has a value, preferably comprised between 5 minutes and 20 minutes.

13. The method according to claim 4, wherein the volatile liquid introduced into the chamber includes, such as ethanol.

14. The method according to claim 5, wherein the box is a Petri dish.

15. The method according to claim 7, wherein the particles have a diameter less than 10 μm.

16. The method according to claim 15, wherein the particles have a diameter less than 1 μm.

17. The method according to claim 7, wherein the surfactant has a concentration at least equal to the critical micellar concentration.

18. The method according to claim 7, wherein the polymer is a polyethylene glycol defined by the following formula: H(—OCH2 CH2—)nOH
wherein n represents the number of oxyethylene unit(s) of the polymer.

19. The method according to claim 11, wherein the biological species are, such as live biological species.

20. The method according to claim 19, wherein the biological species are, for example bacteria.
